(19) United States
(12) Patent Application Publication
(10) Pub. No.: US 2025/0164037 A1
(43) Pub. Date: May 22, 2025

(54) HANGER ASSEMBLY FOR DUCT

(71) Applicant: Rectorseal, LLC, Houston, TX (US)

(72) Inventor: Steven Edward Castillo, Lantana, FL (US)

(73) Assignee: Rectorseal, LLC, Houston, TX (US)

(21) Appl. No.: 18/937,829

(22) Filed: Nov. 5, 2024

Related U.S. Application Data
(60) Provisional application No. 63/659,615, filed on Jun. 13, 2024.
(60) Provisional application No. 63/600,998, filed on Nov. 20, 2023.

(51) Int. Cl. F16L 3/14

(52) U.S. Cl. CPC F16L 3/14

(57) ABSTRACT

A hanger assembly for hanging a duct includes a locking pin and a hanging bracket having an opening formed on a first side of the hanging bracket and a coupler disposed on a second side of the hanging bracket. The locking pin is attached to the duct and the hanging bracket is inserted over both a film layer of the duct and the locking pin by securing the opening of the hanging bracket about both the film layer of the duct and the locking pin.

### CROSS-REFERENCE TO RELATED APPLICATIONS

This application claims priority to and the benefit of U.S. Provisional Application No. 63/659,615 filed Jun. 13, 2024, and U.S. Provisional Application No. 63/600,998 filed Nov. 20, 2023, the entire contents of which are hereby incorporated by reference in their entirety.

### TECHNICAL FIELD

The present disclosure relates to ducts and, more particularly, to an assembly for hanging HVAC ducts.

### BACKGROUND

Heating ventilation and air conditioning (HVAC) systems are traditionally used for maintaining comfortable indoor environments in both residential and commercial buildings. Traditional HVAC systems, especially those for use in private residential structures, such as houses and apartments, move air from an air source to a destination via ductwork or another similar conduit. The ductwork used in traditional HVAC systems may be flexible and mounted in a relatively unobtrusive location, such as underneath a floor, or from a joist or similar overhead support. Furthermore, the ductwork is normally hung using hangers, straps or brackets to secure the duct to the support structure (e.g. a joist, or other similar structure). For example, a strap (such as woven plastic), may be looped around the conduit to encircle the conduit. The strap ends are then brought together and secured to the joist or other support structure by using a nail, screw or other fastener to penetrate the strap ends and the joist.

Although the straps used to hang ductwork of traditional HVAC systems may secure the ductwork to a structure, encircling the duct, as described herein, may cause the strap to pinch or crimp the ductwork, such that the insulation in the ductwork becomes compressed by the weight of the duct. Furthermore, crimping of the duct can be exacerbated if the duct is subject to vibration or movement. In these instances, the movement of the ductwork may cause air flow loss in addition to sweating on an exterior of the duct. Finally, in addition to the sweating issue, utilizing straps to hang ductwork for traditional HVAC systems can be difficult, as an installer must provide temporary support of the duct while they nail or screw in the strap. The strap installation is also complicated because it is often done in confined or elevated spaces.

Accordingly, a need exists for a hanger assembly that minimizes or eliminates pinching, crimping or breach of ductwork while allowing for a more simple and cost-effective installation process.

### SUMMARY

In an embodiment of the present disclosure, a hanger assembly is disclosed. The hanger assembly includes a locking pin and a hanging bracket having an opening formed on a first side of the hanging bracket and a coupler disposed on a second side of the hanging bracket. The locking pin is attached to the duct and the hanging bracket is inserted over both a film layer of the duct and the locking pin by securing the opening of the hanging bracket about both the film layer of the duct and the locking pin.

In another embodiment, a hanger assembly kit for hanging a duct is disclosed. The hanger assembly kit includes a locking pin, a hanging bracket having an opening formed on a first side of the hanging bracket, and a coupler disposed on a second side of the hanging bracket. The locking pin is adhered to a top surface of the duct, a film layer of the duct is deformed about the locking pin to at least partially encircle the locking pin, and the hanging bracket is inserted over both the film layer of the duct and the locking pin by securing the opening of the hanging bracket about both the film layer of the duct and the locking pin.

In yet another embodiment still, a method of securing a duct to a structure using a hanger assembly is disclosed. The method includes positioning a locking pin of the hanger assembly on a surface of the duct; securing the locking pin on the surface of the duct; securing an opening of a hanging bracket of the hanger assembly to the locking pin, such that the locking pin is secured within the opening of the hanging bracket; inserting a strap through a coupler formed on the hanging bracket; and securing the strap to the structure to support the duct therefrom.

### BRIEF DESCRIPTION OF THE DRAWINGS

Other features and advantages of the present disclosure will be understood from the following embodiments described in detail herein and with reference to the accompanying drawings, in which like reference numerals represent the same or similar components.

FIG. 1 is a perspective view of a duct supported by a hanger assembly, according to one or more embodiments shown and described herein;

FIG. 2(a) is a side view of a hanging bracket of the hanger assembly of FIG. 1, according to one or more embodiments shown and described herein;

FIG. 2(b) is a side view of an elongated locking pin of the hanger assembly of FIG. 1, according to one or more embodiments shown and described herein;

FIG. 2(c) is a bottom view of the hanging bracket of FIG. 2(a) including an elongated opening, according to one or more embodiments shown and described herein;

FIG. 3 cross-sectional view of the hanger assembly of FIG. 1 with a locking pin inserted into a protective film of the duct; and

FIG. 4 is cross-sectional view of the hanger assembly of FIG. 1 with a locking pin removed from a protective film of the duct, according to one or more embodiments shown and described herein.

Elements in the figures are shown for simplicity and clarity and are not necessarily drawn to exact scale. It can be understood that these accompanying drawings are not only intended to explain and illustrate the present disclosure and description, but also contribute to the scope of the present disclosure.

### DETAILED DESCRIPTION

The implementation and application of embodiments of a hanger assembly will be discussed in detail below. The hanger assembly may include a locking pin and a hanging bracket having an opening formed on a first side of the hanging bracket and a coupler disposed on a second side of the hanging bracket. The locking pin may be attached to the duct and the hanging bracket may be inserted over the locking pin by securing the opening of the hanging bracket about the locking pin. The connection between the locking pin and the hanging bracket may minimize pinching, crimping or breach of the duct, while also simplifying installation of the duct onto a structure. Although some embodiments of a hanger assembly are described herein, it should be understood that the embodiments are not intended to limit the scope of the present disclosure.

As provided herein, it should be appreciated that the terms “disclosure”, “present disclosure” and variations thereof are not intended to mean every possible embodiment encompassed by this disclosure. Thus, the subject matter of each such reference should not be considered as necessary for, or part of, every embodiment hereof because of such reference.

The term “coupled” and the like, and variations thereof, is intended to mean either an indirect or direct connection or engagement. Thus, if a first device couples to a second device, that connection may be through a direct connection, or through an indirect connection via other devices and connections.

Certain terms are used herein to refer to particular components. However, it should be understood that different persons may refer to a component by different names. This document does not intend to distinguish between components that differ in name but not function.

Furthermore, the terms “including” and “comprising” are used herein in an open-ended fashion, and thus should be interpreted to mean “including, but not limited to.”

Further, reference herein to components and aspects in a singular tense does not necessarily limit the present disclosure to only one such component or aspect, but should be interpreted generally to mean one or more, as may be suitable and desirable in each particular instance.

Preferred embodiments of the present disclosure are well adapted to carry out one or more of the objects of this disclosure. However, the present disclosure does not require each of the components and acts described above and are in no way limited to the above-described embodiments. Any one or more of the above components, features and processes may be employed in any suitable configuration without inclusion of other such components, features and processes. Moreover, the present disclosure includes additional features, capabilities, functions, uses and applications that have not been specifically addressed herein but are, or will become, apparent from the description herein

As noted hereinabove, traditional HVAC systems may utilize straps or brackets to hang ductwork. However, the straps and/or brackets used to hang the ductwork may cause the ducts to crimp and/or sage which may lead to breaches and/or tears in the ducts. Furthermore, the installation process for hanging ductwork using traditional straps and/or brackets can be cumbersome and time-consuming, which may present safety risks for installers and increased labor costs.

The hanger assembly described herein aims to address these shortcomings by providing a more secure and efficient system for suspending ducts. For example, as will be described in detail herein, the hanger assembly may include a locking pin and a hanging bracket that secures the duct without compressing or damaging the duct. By securing the duct without pinching and/or crimping, the hanger assembly provided by the present disclosure may maintain the integrity of the duct while alleviating issues related to air leakage, condensation, and system inefficiency.

Moreover, the hanger assembly described herein simplifies installation of ductwork by allowing for easy engagement of the hanging bracket with the locking pin, thereby reducing the need for temporary support during installation. In embodiments of the present disclosure, the use of couplers, such as handles, on the hanging bracket may further allow for versatile attachment to various support structures, further improving the flexibility and ease of installation. Accordingly, it should be appreciated that the hanger assembly described herein may provide a more durable and efficient system for hanging ducts in both residential and commercial applications.

For purposes of the following disclosure, the term “hanging bracket” may refer to any device that is configured to engage a locking pin when the locking pin is surrounded and/or partially surrounded by at least a portion of a protective layer (e.g. Mylar) of ductwork.

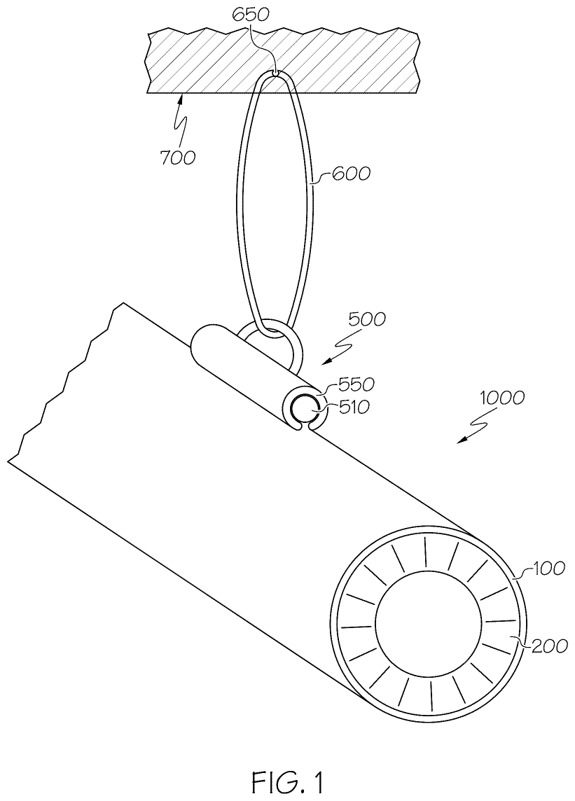

Referring now to FIG. 1, a duct 1000, such as a flexible HVAC duct, with a hanger assembly 500 is depicted. In these embodiments, the duct 1000 may further include a film layer 100, such as a protective film layer, and an insulation layer 200, with the film layer 100 being disposed about and encircling the insulation layer 200. It should be appreciated that the film layer 100 may act as a moisture barrier to prevent fluid infiltration into the insulation layer 200 of the duct, and may further aid in ensuring that the insulation layer 200 does not become damaged during installation and/or operation of the duct 1000. The cylindrical interior volume of the duct 1000 may be used for airflow of an HVAC system as is known in the art. Although the embodiments described herein refer to hanger assembly 500, it should be further appreciated that, in some embodiments, the hanger assembly 500 may be provided as a hanger assembly kit. For example, each of the components of the hanger assembly 500 may be provided in an unassembled kit which may be assembled by a user prior to hanging the duct 1000. In these embodiments, users may utilize components of various hanger assembly kits interchangeably, as will be described herein.

In the embodiments described herein, the film layer 100 may be formed of Mylar (e.g., polyethylene terephthalate, etc.), polyvinyl chloride (PVC), polyethylene, aluminum foil laminate, nylon, or other flame retardant films based on design parameters of the duct 1000, such as durability, insulation, moisture resistance, and fire safety. Furthermore, it should be appreciated that the insulation layer 200 may be formed of fiberglass, polyurethane foam, elastomeric foam, mineral wool (e.g., rock wool, etc.), cellulose fiber, polystyrene foam, or any other similar material capable of meeting thermal efficiency, moisture resistance, and/or fire safety goals of the duct 1000.

As further depicted in FIG. 1, the hanger assembly 500 may be attached to an upper surface of duct 1000. In these embodiments, the hanger assembly 500 may include a locking pin 510, such as an elongated locking pin, which may be secured within a hanging bracket 550. As illustrated in FIG. 1, the locking pin 510 may include a cylindrical body that is insertable within the hanging bracket 550 and allows for the uniform distribution of forces across the locking pin 510 when the locking pin 510 is secured within the hanging bracket 550.

Although the locking pin 510 of FIG. 1 is depicted as including a cylindrical body, it should be appreciated that the locking pin 510 may take any shape without departing from the scope of the present disclosure. For example, in some embodiments, the locking pin 510 may have a rectangular, elliptical, or any other similar shape that may be received within the hanging bracket 550. Furthermore, although not depicted, it should be understood that the locking pin 510 may be tapered, ridged and/or grooved, or threaded without departing from the scope of the present disclosure.

In the embodiments described herein, the locking pin 510 may be formed of plastic, nylon, metal, fiberglass, wood, thermoplastic elastomers, or any other suitable material configured to accommodate a weight of the duct and environmental conditions in which the ductwork is located. Furthermore, in some embodiments, the locking pin 510 may include a surface coating (e.g., PTFE or any other similar material) that may reduce friction between the locking pin 510 and the hanging bracket 550, thereby easing installation of the locking pin 510 within the hanging bracket 550.

Referring still to FIG. 1, the hanger assembly 500 may further include at least one coupler 555, such as a handle. For example, the coupler 555 may protrude from the hanger assembly 500, and may include an aperture configured to receive a strap 600 used to secure the hanger assembly 500 (and, in turn, the duct 1000) to a structure 700. In these embodiments, and as described herein, the strap 600 may be inserted (e.g., threaded or otherwise) through the coupler 555 and attached to the structure 700, such as a building support (e.g. a joist) by securing (e.g., via fastening, piercing, etc.) at least one end of the strap 600 to the structure 700.

Although FIG. 1 depicts the coupler 555 as including a handle, it should be appreciated that the coupler 555 may be any type of coupler without departing from the scope of the present disclosure. For example, in some embodiments, the coupler 555 may include Velcro, snap fits, slits, loops, or any other similar mechanism configured to receive the strap 600 used to secure the hanger assembly 500 and duct 1000 to the building support 700. Furthermore, in the embodiments described herein, it should be understood that the coupler 555 may be attached to any strap like device used to support duct 1000 (e.g. wires, ropes, etc.) to building support 700. Similarly, the strap 600 may be formed of woven nylon straps, polypropylene straps, metal straps, velcro straps, elastic straps (e.g., bungee cords, etc.), rubber straps, wire straps, or any other similar material capable of supporting a weight of the duct 1000 and withstanding environmental conditions in which the strap 600 is used.

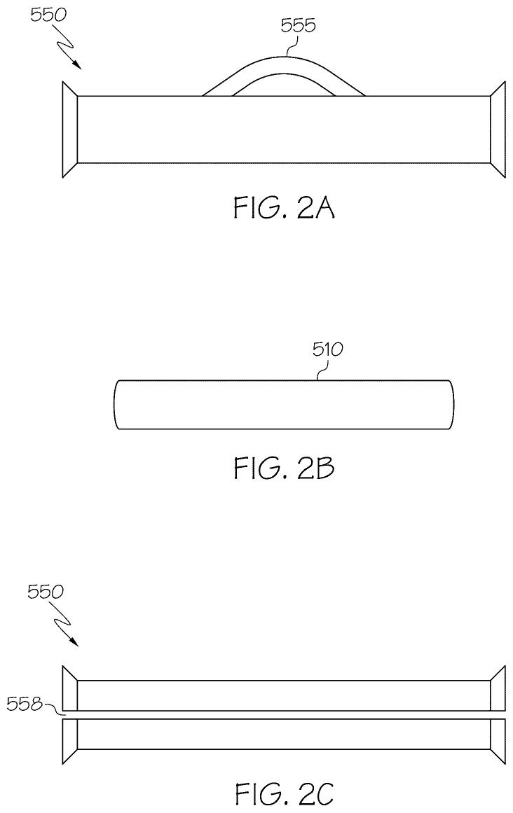

Referring now to FIGS. 2a-2c, the hanger assembly 500 is illustrated in additional detail. For example, as most clearly depicted in FIG. 2c, hanging bracket 550 may further include an opening 558, such as an elongated opening, that is sized and/or shaped to secure both the locking pin 510 and at least a portion of the film layer 100. In these embodiments, the opening 558 may extend at least partially along a length of a bottom surface of the hanging bracket 550 (e.g. between a first end a second end of the hanging bracket.) Furthermore, the opening 558 of the hanging bracket 550 may be elastically deformable, such that the opening 558 may temporarily increase in size (e.g., width) and/or be adjusted in shape to accommodate the locking pin 510 within the hanging bracket 550.

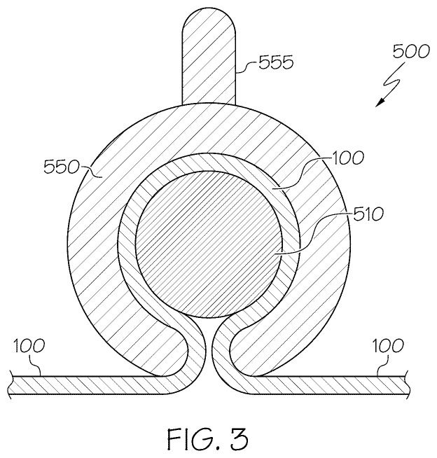

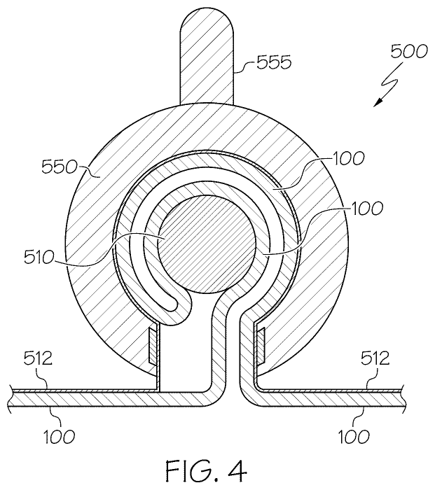

Referring now to FIGS. 3 and 4, the hanging bracket 550 and its elongated opening 558 may be slidably engaged over the locking pin 510 and at least a portion of the film layer 100 or snapped into place over the locking pin 510 and at least a portion of the film layer 100.

For example, in embodiments in which the opening 558 is snap-fit over the locking pin 10 and at least a portion of the film layer 100, the locking pin 510 may be positioned on top of or within the film layer 100. A user may then align the opening 558 of the hanging bracket 550 with the locking pin 510 and press the hanging bracket 550 towards the locking pin 510. As the hanging bracket 550 is depressed, edges of the opening 558 may deform such that the opening 558 temporarily widens and allows the locking pin 510 and the at least portion of the film layer 100 to be received within the opening 558. As the hanging bracket 550 is pressed into place about the locking pin 510, the opening 558 may contract to an original size, thereby securing the locking pin 510 within the hanging bracket 550. It should be appreciated that, in these embodiments, the flexibility of the material allows for a secure connection to be formed between the hanging bracket 550 and the locking pin 510 without utilizing additional fasteners.

Furthermore, it should be appreciated that, in some embodiments, a user may roll the opening 558 of the hanging bracket 550 over the locking pin 510. In these embodiments, contact between the opening 558 and the locking pin 510 may cause the opening 558 to become slightly deformed (e.g., bent, etc.) to ease the rolling action. As the opening 558 of the hanging bracket 550 rolls over the locking pin 510, a diameter of the opening 558 temporarily increases (e.g., elastically deforms) to accommodate the locking pin 510. Once the hanging bracket 550 is secured about the locking pin, the opening 558 may contract to its original dimensions, thereby securing the locking pin 510 and the film layer 100 within the hanging bracket 550. It should be appreciated that the rolling action described herein may be utilized in tight spaces or installations in which a snap-fit may be difficult to achieve.

Referring still to FIGS. 3 and 4, in embodiments in which the hanging bracket 550 is slidably engaged over the locking pin 510 and at least a portion of the film layer 100, the hanging bracket 550 may be a hollow hanging bracket, such that the opening 538 further defines a hole (e.g., through hole, etc.) that may extend between a first end and a second end of the hanging bracket 550. In these embodiments, the hole of the hanging bracket 550 (e.g., the hollow portion of the hanging bracket 550) be larger in diameter than the locking pin 510, such that the hanging bracket 550 may slide over the locking pin 510 to secure the locking pin 510 within the hanging bracket 550.

Referring again to FIGS. 3 and 4, it should be appreciated that the locking pin 510 may be positioned relative to the film layer 100 in a variety of ways. For example, as shown in FIG. 3, the locking pin 510 may be disposed inside of the film layer 100. To dispose the locking pin 510 within the film layer 100, a hole (not depicted) may be formed in the film layer 100, such that the locking pin 510 may be inserted within the film layer 100 and positioned between the film layer 100 and the insulation layer 200. Once the locking pin 510 is positioned within the film layer 100, the hole formed in the film layer 100 may be covered with a tape (or other similar mechanism) to ensure that the locking pin 510 remains secured within the film layer 100.

Referring still to FIG. 3, with the locking pin 510 secured within the film layer 100, a user may grip at least a portion of the film layer 100 around the locking pin 510 and slide (e.g., roll) or snap the opening 558 of the hanging bracket 550 over both the film layer 100 and the locking pin 510, as has been described in detail herein. It should be appreciated that, in these embodiments, the film layer 100 may be positioned between both the locking pin 510 and the hanging bracket 550 once the locking pin 510 is installed in the hanging bracket 550. It should be further appreciated that, in some embodiments, to keep the hanging bracket 550 secured in place, a tape layer may be used to secure the hanging bracket 550 directly to the film layer 100, while leaving coupler 555 uncovered such that the strap 600 may be inserted through the coupler 555.

Turning now to FIG. 4, it should be further understood that, in some embodiments, the locking pin 510 may not be inserted into the film layer 100, as is illustrated in FIG. 3. In this embodiment, the locking pin 510 may be placed on a top surface of duct the 1000, and a tape layer may be disposed over the locking pin 510 to secure the locking pin 510 in position on the duct 1000. Once the locking pin 510 is secured to the duct 1000, the film layer 100 may be rolled around pin 510 (e.g., as described hereinabove) and held in place by the user or via a second tape layer disposed over both the locking pin 510 and the film layer 100. With the film layer 100 positioned about the locking pin 510, the opening 558 of the hanging bracket 550 may be slid, snapped, and/or rolled about the locking pin 510 as has been described herein.

Referring now collectively to FIGS. 1-4, it should be appreciated that the size and weight of the duct 1000 may impact the size and length of the locking pin 510 and hanging bracket 550. In embodiments in which a standard duct is utilized (e.g., a duct being from 4 inches to 20 inches), a length of the hanging bracket 550 may be from approximately 4 inches to 12 inches, while a diameter of the locking pin 510 may be from approximately 0.2 inches to 0.5 inches. However, it should be appreciated that the locking pin 510 may have any length and any diameter without departing from the scope of the present disclosure.

Furthermore, it should be appreciated that, in some embodiments, the size (e.g., length, diameter, etc.) of the locking pin 510 and the hanging bracket 550 may be increased in order to accommodate a larger duct. Although the hanging bracket 500 is depicted as having a single coupler 550, in the embodiments described herein, the hanging bracket 550 may include a plurality of couplers 555 spaced along a length of the hanging bracket 550 and configured to distribute a weight of the duct 1000 evenly across the hanging bracket 550.

In view of the foregoing, it should be appreciated that a hanger assembly is described herein. The hanger assembly may include a locking pin and a hanging bracket having an opening formed on a first side of the hanging bracket and a coupler disposed on a second side of the hanging bracket. The locking pin may be attached to the duct and the hanging bracket may be inserted over the locking pin by securing the opening of the hanging bracket about the locking pin. The connection between the locking pin and the hanging bracket may minimize pinching, crimping or breach of the duct, while also simplifying installation of the duct onto a structure. Furthermore, hanging a duct using the hanger assembly described herein may allow for the duct to keep a desired shape without causing condensation and potential water damage.

Many different arrangements of the various components depicted, as well as components not shown, are possible without departing from the scope of the present disclosure. Embodiments of the technology have been described with the intent to be illustrative rather than restrictive.

Alternative embodiments and alternative means of implementing the aforementioned may be completed without departing from the scope of the present disclosure. Certain features and sub-combinations may be employed without reference to other features and sub-combinations and are contemplated within the scope of the disclosure.

It should be understood that the embodiments as shown in the drawings only show the optional shapes, sizes and arrangements of optional components of the trampoline according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that various variations and improvements to the concepts disclosed above, and all the variations and improvements fall into the scope of protection of the present disclosure. The descriptions of the above embodiments are illustrative but not restrictive, and the scope of protection of the present disclosure is determined by the claims.

1. A hanger assembly for hanging a duct, the hanger assembly comprising:
a locking pin; and
a hanging bracket having an opening formed on a first side of the hanging bracket and a coupler disposed on a second side of the hanging bracket;
wherein the locking pin is coupled to the duct and the hanging bracket is coupled to both a film layer of the duct and the locking pin by securing the locking pin to the hanging bracket.

2. The hanger assembly of claim 1, wherein the coupler comprises a handle configured to receive a strap used to hang the duct from a structure.

3. The hanger assembly of claim 1, further comprising a tape layer disposed over the locking pin to secure the locking pin to a top surface of the duct.

4. The hanger assembly of claim 1, wherein the opening of the hanging bracket is elastically deformable to accommodate the locking pin.

5. The hanger assembly of claim 1, wherein the locking pin is inserted within a hole formed in the film layer of the duct.

6. The hanger assembly of claim 1, wherein at least a portion of the film layer of the duct is rolled about the locking pin, such that the portion of the film layer of the duct at least partially encloses the locking pin and is inside the hanging bracket.

7. The hanger assembly of claim 1, wherein the film layer comprises Mylar.

8. The hanger assembly of claim 1, wherein the coupler includes a plurality of couplers positioned across a length of the hanging bracket.

9. The hanger assembly of claim 1, wherein the duct further comprises an insulation layer, the film layer of the duct is disposed about the insulation layer, and the locking pin is disposed between the film layer and the insulation layer of the duct.

10. The hanger assembly of claim 1, wherein the locking pin has a diameter in a range of about 0.2 inches to about 0.5 inches.

11. The hanger assembly of claim 1 wherein the hanging bracket has a length in a range of about 4 inches to about 12 inches.

12. A hanger assembly kit for hanging a duct, the hanger assembly kit comprising:
a locking pin; and
a hanging bracket having an opening formed on a first side of the hanging bracket and a coupler disposed on a second side of the hanging bracket;
wherein the locking pin is adhered to a top surface of the duct, a film layer of the duct is deformed about the locking pin to at least partially encircle the locking pin, and the hanging bracket is inserted over both the film layer of the duct and the locking pin by securing the opening of the hanging bracket about both the film layer of the duct and the locking pin.

13. The hanger assembly kit of claim 12, wherein the coupler includes a handle configured to receive a strap used to hang the duct from a structure.

14. The hanger assembly kit of claim 12, further comprising a tape layer disposed over the locking pin and the film layer to secure the film layer about the locking pin.

15. The hanger assembly kit of claim 12, wherein the opening of the hanging bracket is elastically deformable to accommodate the locking pin.

16. The hanger assembly kit of claim 12, wherein the film layer is formed of Mylar.

17. The hanger assembly kit of claim 12, wherein the coupler includes a plurality of couplers positioned across a length of the hanging bracket.

18. The hanger assembly kit of claim 12, wherein the duct further comprises an insulation layer, the film layer of the duct is disposed about the insulation layer, and the locking pin is disposed between the film layer and the insulation layer of the duct.

19. A method of securing a duct to a structure using a hanger assembly, the method comprising:
positioning a locking pin of the hanger assembly on a surface of the duct;
securing the locking pin on the surface of the duct;
securing an opening of a hanging bracket of the hanger assembly to the locking pin, such that the locking pin is secured within the opening of the hanging bracket;
inserting a strap through a coupler formed on the hanging bracket; and
securing the strap to the structure to support the duct therefrom.

20. The method of claim 19, wherein securing the locking pin on the surface of the duct further comprises deforming at least a portion of a film layer of the duct about the locking pin, such that the film layer at least partially enclosed the locking pin.
